(19) United States
(12) Patent Application Publication
(10) Pub. No.: US 2004/0021993 A1
(43) Pub. Date: Feb. 5, 2004

(54) Electric equipment for motor vehicles

(76) Inventors: Xavier Lambin, Gizaucourt (FR); Karim Benghezal, Chalons En Champagne (FR)

Correspondence Address: Blakely Sokoloff Taylor & Zafman, 7th Floor, 12400 Wilshire Boulevard, Los Angeles, CA, 90025, US

(21) Appl. No.: 10/333,762

(22) PCT Filed: Jul. 24, 2001
(86) PCT No.: PCT/FR01/02412

(51) Int. Cl. B60R 16/02; H02H 5/04

(52) U.S. Cl. 361/23

(57) ABSTRACT

The present invention relates to electrical equipment for motor vehicles, the equipment comprising an electrical member (10) having a housing that is at least partially electrically conductive, an electrical filter (30) disposed on the power lines (22, 24) of the electrical member (10), and electrical connection means for electrically connecting the housing (11) to the ground line (24) of the filter, the equipment being characterized by the fact that the connection means for connecting the housing (11) of the electrical member (10) to the ground line (24) of the filter (30) comprise at least one serial component (40) of inductive type.

The present invention relates to the field of electrical equipment for motor vehicles.

It applies particularly, but not exclusively, to pump systems for pumping fuel, e.g. gasoline, from a motor vehicle tank.

Still more precisely, the present invention relates to a filter device for such equipment for filtering against electrical and/or electromagnetic disturbances, and in particular against disturbances conveyed over the power cables of such equipment.

Current standards impose limiting the electromagnetic disturbances to below ever-decreasing thresholds.

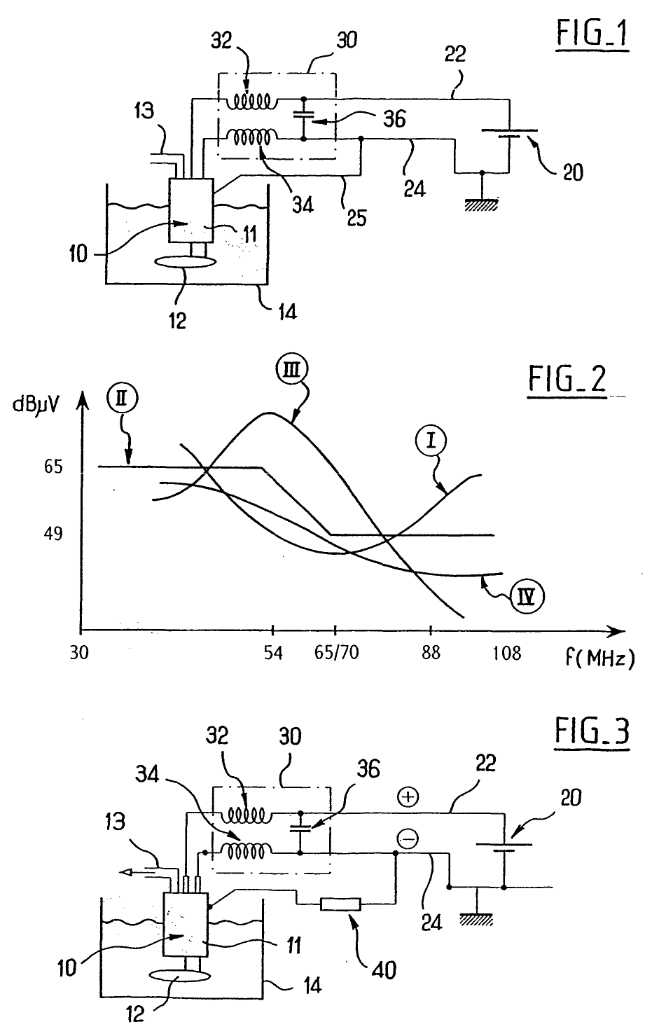

Accompanying FIG. 1 is a diagram showing the structure of conventional fuel-pumping equipment provided with a known filter device.

FIG. 1 shows a pump 10 actuated by a direct current (DC) electric motor having an inlet strainer 12 that is placed in the vicinity of the bottom of a fuel tank 14. The fuel outlet of the pump 10 is referenced 13. The pump 10 is electrically powered by a battery 20 via two lines 22, 24, and the two lines 22, 24 are associated with a filter 30. As shown in FIG. 1, the filter 30 comprises two chokes 32, 34 placed on the lines 22 and 24 respectively, and a capacitor 36 placed between the lines 22, 24 on their battery side. In addition, the ground line 24 is connected via an auxiliary electrical connection line 25 to the metal housing 11 of the pump 10.

In the past, equipment of the type shown in FIG. 1 has been installed in very many motor vehicles.

The decibel microvolt (dBμV) response as a function of frequency is shown by curve I in FIG. 2. Also in FIG. 2, the characteristic or limit imposed by current standards is referenced II.

It can clearly be seen that for high frequencies (typically greater than 60 megahertz (MHz)), the known filter is unable to comply with the standards since the disturbance level exceeds the authorized limit.

Various propositions have been made in an attempt to improve the situation.

It has thus been proposed to eliminate the line 25 considering that said line could perhaps play a harmful role as an antenna. However, that attempt has not been satisfactory. The response thus obtained is referenced III in FIG. 2.

It has also been proposed to overdimension (in value and volume) the chokes 32, 34 compared to known prior-art devices. However, that attempt has also not been satisfactory because it has not been able to comply with the compactness required for the internal and external mechanical environment of the equipment concerned, in particular in the case of a fuel-pump system.

An object of the present invention is to propose novel means enabling the level of electrical and/or electromagnetic disturbances to be reduced compared to known filter devices.

This object is achieved in the context of the present invention by means of equipment comprising an electrical member having a housing that is at least partially electrically conductive, an electrical filter disposed on the power lines of the electrical member, and electrical connection means for electrically connecting the housing to the ground line of the filter, the equipment being characterized by the fact that the connection means for connecting the housing of the electrical member to the ground line of the filter comprise at least one serial component of inductive type.

According to an advantageous characteristic of the present invention, the serial connection component of inductive type is formed by a ferrite bar or ring.

Other characteristics, objects, and advantages of the present invention appear on reading the following detailed description, and with reference to the accompanying drawings, given by way of non-limiting example, and in which:

FIG. 1 described above, is a diagram showing a known system in accordance with the prior art;

FIG. 2 described above in part, shows at I and III the response curves of various filters in accordance with the prior art, at II a characteristic or limit imposed by standards, and at IV the response of a filter in accordance with the present invention;

FIG. 3 shows a system in accordance with the present invention; and

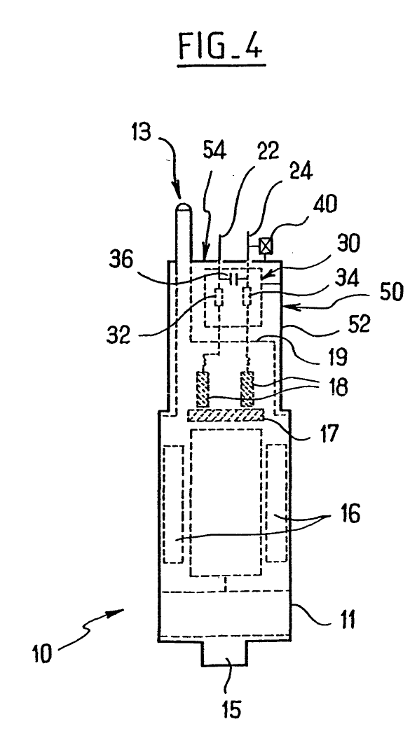

FIG. 4 is a more detailed view of a pump device in accordance with a preferred variant of the present invention.

FIG. 3 shows equipment comprising, in a fuel tank 14, a pump 10 having a housing 11 that is at least partially conductive, said pump including an inlet strainer 12 situated in the vicinity of the bottom of the tank 14, and a fuel outlet 13. The pump 10 is actuated by a DC electric motor by two lines 22, 24 leading to a battery 20.

The two lines 22, 24 are associated with a filter 30. The filter comprises two chokes 32, 34 placed on the lines 22 and 24 respectively, and a capacitor 36 placed between the lines 22, 24 on their battery side.

As can be seen in FIG. 3, according to an essential characteristic of the invention, the line 24, in its segment situated between the choke 34 and the battery 20, is connected to the electrically conductive housing 11 of the pump 10 via a component 40 of inductive type.

Still more precisely, in the context of the present invention, the component 40 is preferably formed by a ferrite bar or core, or indeed by a ferrite ring. However, in the context of the invention, the component 40 could also be formed by a coil.

The response obtained as a result of adding such a component 40 in accordance with the invention is shown at IV in FIG. 2. A glance at this figure shows that the component 40 enables the performance specifications imposed by current standards to be satisfied.

More precisely, it can be observed that as a result of the presence of the component 40, preferably constituted by a ferrite, any increase in the response at high frequency is eliminated, unlike case I where the filter is directly grounded and in which the response increases at high frequency, and that an intermediate peak cannot be observed as in case III in which there is no grounding.

Thus, the addition of a mini ferrite choke or core 40 on the grounding connection enables an acceptable curve to be obtained which corrects the fault encountered in the prior art at high frequencies, in particular frequencies lying in the range 60 MHz to 110 MHz. The present invention thus makes it possible to comply with defined standards in the FM band (88 MHz to 108 MHz) and the FMX band (65 MHz to 88 MHz), in particular.

The filter 30 can be fixed by any appropriate means on the pump body 10 itself. For example, the filter 30 can preferably be clipped onto the pump 10, at the top thereof.

FIG. 4 shows a preferred installation of the filter 30 at the top of the pump 10.

In FIG. 4, the fluid inlet is referenced 15, the magnets of the electric motor are referenced 16, the commutator is reference 17, the brushes are referenced 18, and the conventional outlet cover of the pump 10 is referenced 19. Nowadays, in most cases, the top portion of the pump, in particular the cover 19, is made of plastics material. It is therefore capable of passing the electromagnetic radiation produced by brushes 18 rubbing on the commutator 17 of the motor.

To improve the elimination of electromagnetic disturbances without fundamentally modifyinq the structure of the present pumps, it is thus proposed, in the context of the present invention, to add a metal body 50 to the metal housing 11 of the pump 10, said metal body completely covering the brushes 18 and the associated brush carrier, as well as the filter 30. The body 50 therefore covers the cover 19.

Naturally, the additional housing 50, preferably made of metal and forming a Faraday cage, must be mechanically and electrically connected to the metal housing 11 of the pump 10. In addition, it is connected by means of the component 40 to the ground line 24.

The addition of such a metal cage 50 clipped onto the pump body 11 reduces the electromagnetic disturbances emitted by radiation and carried over the power wires 22, 24. The housing 50 forming a Faraday cage is preferably made of a vertical axis cylindrical sleeve 52 that is coaxial with the pump body 10, and closed on top by a transverse partition 54 pierced only to enable the fluid outlet 13 to pass therethrough, and to enable electrical connections to pass therethrough leading to the filter 30 so as to power the DC motor. It has been observed that the addition of such a housing 50 forming a Faraday cage enables radiated electromagnetic disturbances to be substantially reduced, in particular over the frequency band 30 MHz to 1000 MHz.

However, the housing 50 forming a Faraday cage can be embodied in numerous ways. In particular, in some variants, it can be imagined that the housing 50 is not circularly cylindrical.

The housing 50 is preferably made of a copper alloy, e.g. a cupro-nickel, or even a bronze alloy, e.g. CuSn3Zn9.

Naturally, the present invention is not limited to the particular embodiments described above, but extends to any variant within the ambit thereof.

1/ Electrical equipment for motor vehicles, the equipment comprising an electrical member (10) having a housing that is at least partially electrically conductive, an electrical filter (30) disposed on the power lines (22, 24) of the electrical member (10), and electrical connection means for electrically connecting the housing (11) to the ground line (24) of the filter, the equipment being characterized by the fact that the connection means for connecting the housing (11) of the electrical member (10) to the ground line (24) of the filter (30) comprise at least one serial component (40) of inductive type.

2/ Equipment according to claim 1, characterized by the fact that the serial connection component (40) of inductive type is formed by a ferrite bar or ring.

3/ Equipment according to claim 1, characterized by the fact that the serial connection component (40) of inductive type is formed by a coil.

4/ Equipment according to any one of claims 1 to 3, characterized by the fact that the electrical member is a pump actuated by a DC motor.

5/ Equipment according to claim 4, characterized by the fact that the filter (30) is fixed at the top of the pump (10), and is preferably clipped.

6/ Equipment according to claim 4 or claim 5, characterized by the fact that the pump includes a cover (19) made of plastics material, and that an additional metal housing (50) forming a Faraday cage is also provided covering at least the brushes of the drive motor of the pump.

7/ Equipment according to claim 6, characterized by the fact that the additional housing (50) is clipped onto the body (11) of the pump.

8/ Equipment according to claim 6 or claim 7, characterized by the fact that the additional housing (50) is connected to the ground line of the filter (30) by means of the component (40) of inductive type.

9/ Equipment according to any one of claims 6 to 8, characterized by the fact that the additional housing (50) is made of a copper alloy.

10/ Equipment according to any one of claims 1 to 9, characterized by the fact that the electrical filter (30) comprises two chokes (32, 34) placed on the respective power lines (22, 24) of the electrical member (10), and a capacitor (36) placed between the lines 22, 24).
